(19) United States
(12) Patent Application Publication
(10) Pub. No.: US 2014/0025562 A1
(43) Pub. Date: Jan. 23, 2014

(54) ENHANCED CREDIT REPORTING SYSTEM, METHOD AND COMPUTER PROGRAM PRODUCT

(71) Applicant: CORELOGIC SOLUTIONS, LLC., Irvine, CA (US)

(72) Inventors: Debra ROTHROCK, Carlsbad, CA (US); Ajainath Nair, San Marcos, CA (US); Rao Mylavarapu, San Diego, CA (US); Hamin Balaporia, San Marcos, CA (US)

(73) Assignee: CORELOGIC SOLUTIONS, LLC., Irvine, CA (US)

(21) Appl. No.: 13/944,605

(22) Filed: Jul. 17, 2013

Related U.S. Application Data
(60) Provisional application No. 61/673,126, filed on Jul. 18, 2012.

(51) Int. Cl. G06Q 40/02; G06Q 50/16

(52) U.S. Cl. CPC G06Q 40/025; G06Q 50/16
USPC 705/38

(57) ABSTRACT

A system, method and computer program product cooperate to gather and report information relevant to a consumer's credit that is not typically reported on a credit report from one of the major credit bureaus. By accessing other databases regarding borrower specific financially relevant information (e.g., judgments, liens, rental payment compliance, alternative credit transactions, etc.), enhanced data is available for making better lending decisions. Removal of transactions that would prevent compliance with the Fair Credit Reporting Act is performed, as well as removal of transactions that are erroneous for a particular consumer or include information that are not associated with that particular consumer.

### CROSS-REFERENCE TO RELATED PATENT DOCUMENTS

The present application contains subject matter related to that disclosed in U.S. Pat. No. 5,274,547, and commonly owned U.S. patent application Ser. No. 13/644,905 the entire contents of each of which being hereby incorporated herein by reference in their entirety. The present application also claims the benefit of the earlier filing date of commonly owned U.S. Provisional Patent Application 61/673,126 filed on Jul. 18, 2012, the entire contents of which being hereby incorporated by reference in its entirety.

### BACKGROUND

1. Field of the Disclosure

The present disclosure relates to systems, methods and computer program product for developing and reporting enhanced credit reports. The enhanced credit reports contain supplemental material above and beyond that disclosed in credit reports provided by various credit bureaus.

2. Description of the Related Art

The background description provided herein is for the purpose of generally presenting the context of the disclosure. Work of the presently named inventor, to the extent it is described in the background section, as well as aspects of the description which may not otherwise qualify as prior art at the time of filing, are neither expressly or impliedly admitted as prior art with respect to the present invention.

The first third-party credit reporting agencies were established in the early 1830s. These agencies eventually came to function much like modern-day franchises, with a national scope. These agencies are presently recognized as being dominated by three major credit bureaus: Equifax, Experian (formerly TRW) and TransUnion. These credit bureaus provide a credit report which is a record of credit activities for individuals. The credit reports list any credit-card accounts or loans that an individual may have, as well as balances and how regularly the individual makes payments. In addition, the credit reports indicate whether any action has been taken against the individual because of unpaid bills. There are five major components to a conventional credit report. These include personal identifying information, such as name, address (current and previous), social security number, and optionally telephone number, birth date, and current and previous employers.

The credit report also includes credit history which includes a section on bill paying history with banks, retail stores, finance companies, mortgage companies and other entities that have granted credit to the individual. This credit history includes information about each account the individual has, such as when it was opened, what type of account it is, how much credit is granted on the account, and what is the monthly payment that is due. If the account is closed or the loan has been paid off, that information will be included in the report as well.

The credit report may include credit worthiness related tax liens, court judgments and bankruptcies.

Also, the credit report may include report inquiries which list all credit grantors who have received a copy of the credit report within a specified timeframe, and other authorized entities that have viewed the credit report. In addition, the credit reporting system tracks the companies that have received the name and address in order to offer the individual a firm offer of credit.

The report may also include consumer statements that, among other things, include disputes that the individual may have made regarding the report following reinvestigation. Both the consumer and the creditor may make statements on the report. Each of the three major credit bureaus gets its information because they serve as clearinghouses for credit information about customers. In addition to the three national credit bureaus, there are more than 1,000 local and regional credit bureaus around the country that obtain information directly from the individual's creditors. These smaller local and regional bureaus are typically affiliated with one of the three national credit bureaus.

The activities of all credit bureaus are governed by the Fair Credit Reporting Act, which is a U.S. federal law (35 U.S.C. §1681) that regulates the collection, dissemination and use of consumer credit information. The Fair Credit Reporting Act places strict requirements on the consumer credit reporting agencies. For example, the nationwide consumer credit reporting agencies must make available to consumers information about them contained in the agency's files, upon request and at no charge at least once per year. Also if negative information is removed as a result of a consumer's dispute, it may not be reinserted (after verification) without notifying the consumer within five days in writing. Also, the consumer reporting agencies may not retain negative information for an excessive period. For example, the Fair Credit Reporting Act places restrictions on how long negative information, such as late payments, bankruptcies, liens or judgments may stay on a consumer's credit report, which is typically seven years from the date of delinquency. One exception is bankruptcies, which may stay on the record for ten years, and tax liens which may stay on the record seven years from the time they are paid.

One of the CORELOGIC business lines is termed CREDCO, which provides data stored in one of the world's largest consumer databases, and provides data to various market end users and investors via CREDCO's proprietary FCRA compliant fully scalable Supplemental Bureau (which includes a data merge function) technology platform. A more detailed description of CREDCO's system is described in U.S. Pat. No. 5,274,547.

Many products and services are provided on the basis of an agreement or expectation that the consumer will make one or more future payments. For example, in the case of a mortgage, auto loan, credit card, installment payment plan, or medical procedure, the consumer receives a product or service with the expectation that they will pay for it (possibly with interest) in the future. In the case of an auto lease or apartment rental, the consumer receives the use of a product, and the arrangement will only be beneficial to the provider of the product if the consumer pays for the use of the product for a minimum period of time. In such cases, the provider (“lender”) of the product or service would like to be able to ascertain the consumer's ability and likelihood to pay in the future. This need has led to the establishment of the above-described credit bureaus that collect data about consumers and furnish credit reports, credit attributes, and credit scores that lenders can use to decide whether to provide the product or service and terms of providing the product or service (risk-based pricing).

Service providers can also use credit information for account management, for example in deciding whether to increase the amount of a line of credit, to modify loan parameters, or to provide promotion/retention offers. Finally, credit information is sometimes used in other areas such as employment and security clearance decisions, where credit risk is thought to be correlated with other behavioral risk.

FIG. 1 shows a schematic view of a conventional credit report 10. The credit report among other things includes personal identifying information and includes among other things name, address, social security number, telephone number, birth date, present and previous employers. This information is presented in a personal identifying information area 11. The credit history 12 is also reported and includes a section regarding bill-paying history with banks, retail stores, etc. The credit history also indicates what entities have granted credit to the individual, and includes information about each account presently opened and formerly opened by the individual, and paid obligations for a specified timeframe. Public records 13 includes information regarding credit worthiness, such as tax liens, court judgments and bankruptcies. Report inquiries 14 describes a section that includes all credit grantors who have received a copy of the credit report within a specified timeframe. It also includes any others who are authorized to view the credit report. Dispute statements 15 include a summary of statements made, such as disputing information on the report.

A credit score is different than a credit report in that the credit score is based on a formula that uses information in the report, but is not a part of the report. Fair Isaac Corporation developed a proprietary scoring system that most creditors use in assigning credit risk. Information contained in the credit report is used to calculate the credit score.

### SUMMARY

It is to be understood that both the foregoing general description of the disclosure and the following detailed description are exemplary, but not restrictive of the present disclosure. The present inventor recognized that conventional credit reports offered by the three major credit bureaus lack certain relevant information that may be used by market players if it were readily available. Moreover, the present inventor recognized that the three major credit bureaus receive their information through a network of smaller local, regional and national information furnishers such as credit card companies, auto finance companies, mortgage banking institutions, etc. In this way, the three major credit bureaus are generally “reactive” in operation, rather than “proactive” in seeking information to populate the credit reports with supplemental information.

The present inventor recognized some significant opportunities that arise by having access to national databases that include, among other things, financially obligated public records, Teletrack alternative credit transactions, extensive SafeRent multi-family tenant experience, evictions, tax records, as well as other data types including utilities, telecommunications, automobile payments, etc., offering information that compliments that available through conventional credit data provided by the credit bureaus. Furthermore, CORELOGIC offers extensive property databases, associated with real property, including property summary data, full transaction history about a property, publicly available filings made with regard to a property (deeds, liens, etc.), estimated market value, and other property details associated to an individual during the time of ownership. Moreover, the CORELOGIC databases contain nearly one billion consumer credit transactions, covering 99.9% of the U.S. population in property transactions including county, municipal and special tax jurisdictions, residential properties, liens and courthouse records, in addition to the aforementioned data types.

By merging the consumer property ownership, property legal filings, tax payment status, rental applications, collections and evictions, inquiries, loans and charge offs from payday and alternative credit lenders, and consumer-specific bankruptcies, liens, judgments, and child support obligations to create a consumer credit report, with or without conventional credit report data, CORELOGIC provides a much more comprehensive report and thus more valuable input for lenders to make more informed lending decisions that ultimately help improve overall loan portfolio value and performance, and enable lending to a broader consumer base.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram of an example conventional credit report;

FIG. 2 is a block diagram of a system and network employed in an embodiment of the present disclosure;

FIG. 3 is an example of an enhanced credit report produced according to an embodiment of the present disclosure;

FIG. 4 is an excerpt of a property summary portion of the enhanced credit report of FIG. 3;

FIG. 5 is an excerpt of a landlord/tenant inquiry portion of the enhanced credit report of FIG. 3;

FIG. 6 is an excerpt of a confirmed property transaction history portion of the enhanced credit report of FIG. 3;

FIGS. 7a and 7b are excerpts of a credit history portion of the enhanced credit report of FIG. 3;

FIG. 8 is an excerpt of a public records portion of the enhanced credit report of FIG. 3;

FIG. 9 is a flow diagram, showing a process flow for producing a credit report according to the present disclosure;

FIG. 10 is a flow chart describing a more detailed purge process according to the present disclosure;

FIGS. 11, 12 and 13 are tables of attributes used in creating an education score, as one example of an enhanced credit score; and

FIG. 14 is a block diagram of a computer system that may be employed according to the present disclosure.

### DETAILED DESCRIPTION

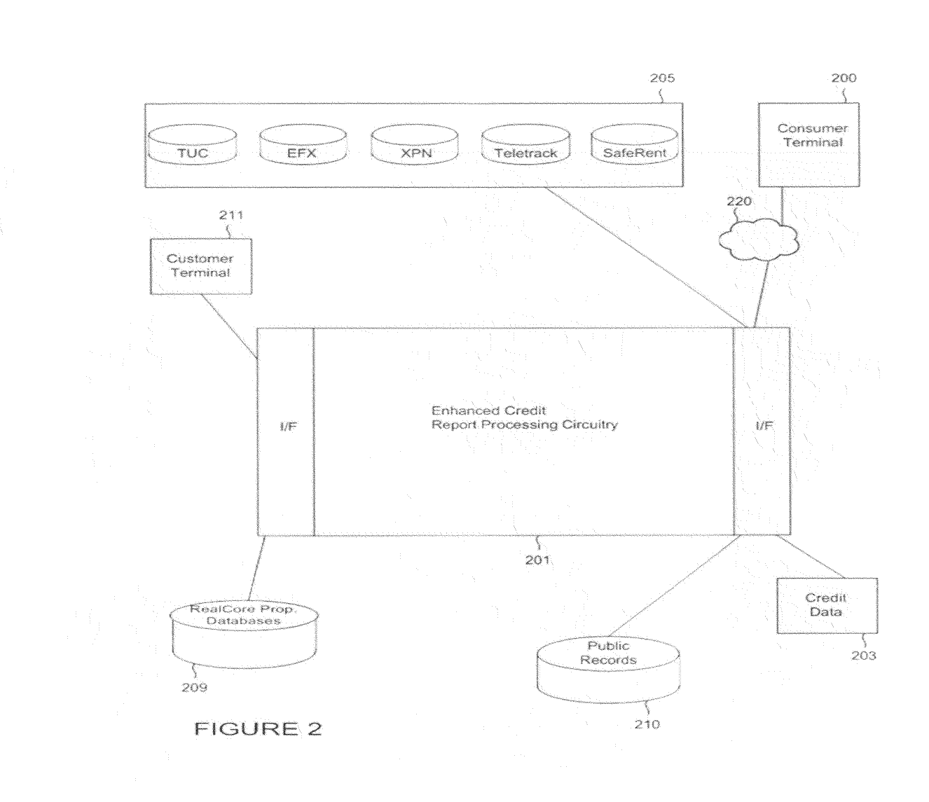

Referring now to the drawings, wherein like reference numerals designate identical or corresponding parts throughout the several views, FIG. 2 is a block diagram of the system components employed according to an embodiment of the present disclosure. A consumer may coordinate directly or through a representative to provide access to information contained in the CORESCORE enhanced credit reporting system shown in FIG. 2. Using a computer (or consumer terminal) 200 with a browser or system-to-system, the user may provide, via a wired or wireless network 220, a computer-based query to an interface I/F of an Enhanced Credit Report Processing Circuitry (ECRPC) 201. The ECRPC 201 may be a single computer, or a distributed computer system that has multiple processors connected either directly or through an intermediate network communications channel.

The ECRPC 201 includes various modules that are implemented by a programmed processor, including a data manager module that manages data associated with information that is legally collectible according to the Fair Credit Reporting Act. This module procures credit report information from credit data 203, which is a database that retains CORELOGIC credit data such as identifying information, inquiries and consumer statements. Also included in the ECRPC 201 is a consumer service manager module that keeps track of consumer information and provides the ability to produce the data report to those consumers. An application module allows for interaction and queries to be made to the data manager module and service manager module in ECRPC 201. The ECRPC 201 also provides a data manager interface that corresponds with other credit reporting agency data sources 205 that include among other things data source TUC (TransUnion), EFX (Equifax), XPN (Experian), Teletrack (a database of payday and alternative credit consumer transactions) and SafeRent (a service that maintains in a database information regarding landlord/tenant and public court records about individuals. Public records are obtained from courts in many jurisdictions. We also maintain some collection and sub-prime data). In addition, ECRPC 201 employs data suppression logic module that removes redundancies and data gathered from different databases in a supplemental bureau system that gathers information from various input sources and provides compliance with the Fair Credit Reporting Act for the data that is included. In particular, the supplemental bureau system includes direct network access to other CORELOGIC FCRA databases that maintain lien/judgment/bankruptcy public information, and RealCore FCRA (which includes property and ownership information synchronized with RealCore non-FCRA information). The information provided to the lien/judgment/bankruptcy database is information of ADC from a SQL database. Also, an extractor is used to extract information from RealCore non-FCRA database that is synchronized with the RealCore FCRA database. Likewise, ECRPC 201 may also exchange information with the other FCRA data sources 205 as shown.

CORELOGIC customers may also have access to the FCRA platforms that are part of the CORELOGIC family of databases (RealCore Property databases 209) that include among other things DATA HQ, MAESTRO, TELETRACK, SAFERENT, etc. Also, a manual investigation request may be made from a system representative to the data sources 205, 209 and 210 as shown.

With regard to ECRPC 201 it should be noted that the data manager interface provides post investigation results, posts inquiries, request FCRA metadata, post re-instatement notification, and temporary pin authorization for providing security access to selected databases. The consumer services interface also handles the ability to post disputes, manage headers, request headers, request consumer copies, procure report data, fetch task, and manage document bundles. In managing the headers, considerations include alerts, security freeze, consumer statements, disputes, transactions, inquiries, addresses and contact information, each of which may be components of the headers. The headers are used as information to track queries and data available for retrieval for particular consumers.

Credit requests were selected from CORELOGIC's CREDCO mortgage clients during a three-month period. The request data included borrower name, current address, social security number, and optionally the date of birth and previous address. If a co-borrower is input on the request, their name, social security number and optional date of birth would also appear. This request data was then submitted to be processed against owner connect service and the alternate data collection file of public record items. The resulting data that matched to the borrower was then compared to merged credit reports. An analysis was then performed to determine which data from the CREDCO archive was unique information for the borrower. This data was found to determine which data CORELOGIC would be able to provide that was relevant to a credit evaluator of a consumer and was concluded to provide substantially valuable information that was not presently included in credit reports from credit bureaus. The CORESCORE system (FIG. 2) serves as a central capability within a CORELOGIC CREDCO system to continually add new data for products. RealCore property data will be available in the report along with borrower-specific judgments, liens and bankruptcies from an ADC file. The RealCore property database and the ADC files are uploaded as replacement files on a periodic basis (e.g., daily) into an FCRA database infrastructure. The FCRA ADC file is accessed through a stored procedure call by a CORESCORE service. Here a special search and match process is performed to locate the appropriate customer records within the database. A similar capability would exist for the FCRA Tax Payment file. Access to the RealCore FCRA database is performed through RIPT using CORELOGIC's owner connect product functionality. Upon submission of an owner connect request with the input borrower names, social security numbers and current address, the owner connect product starts the transaction. An initial step is to contact LEXIS/NEXIS to obtain additional names and addresses associated to that borrower. The return identifications are used in the property searching process. Additionally, the loan application database is used as a source of additional names and addresses for consumers to augment the property search.

During the owner connect search of property records, an iterative search is invoked to seek other qualifying records for the borrower that match the mailing address found in the initial property database. This is helpful to locate properties such as second homes or those named in a trust. A match is then sought. SAFERENT and TELETRACK CRA business information may be available. This is accessed by the credit score service as a real-time query that combines the return data along with property and original public record data into a consolidated report. Lenders can access the consolidated credit report via XML, browser, or batch.

This combination of access allows for information provided by CORELOGIC and accessible by CORELOGIC CREDCO FCRA databases to supplement traditional credit report information. Moreover, the credit information may then be used to collect additional types of non-traditional data about consumers such as rental payments, utilities, telecommunications, etc.

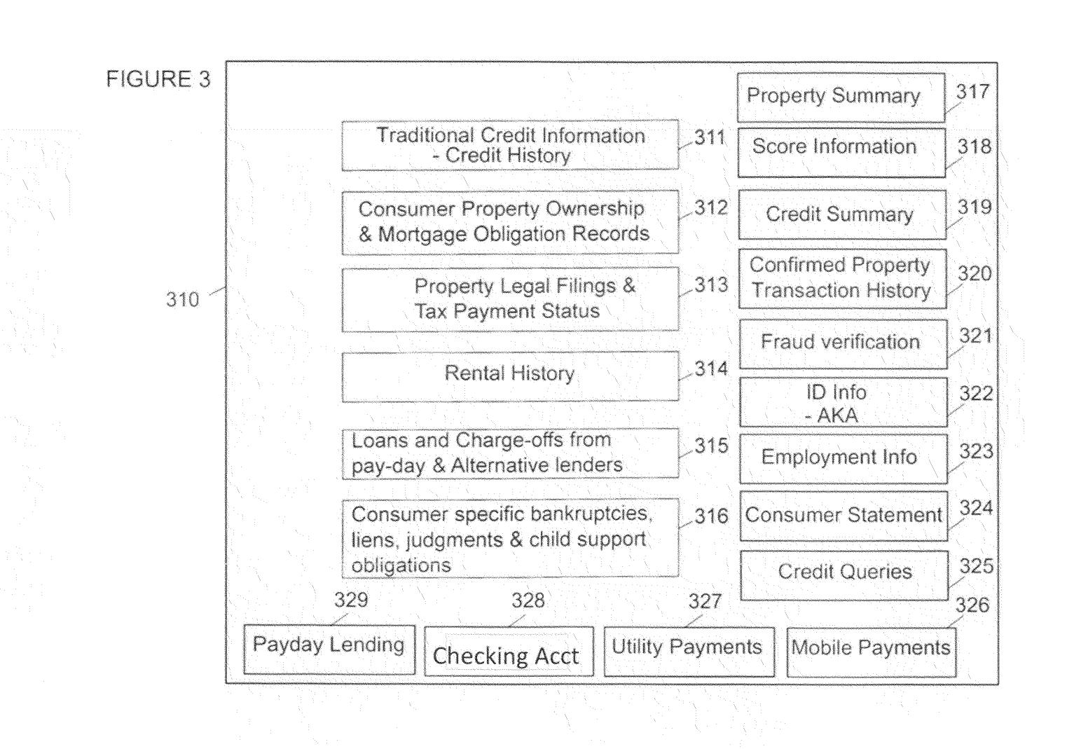

FIG. 3 is a simplified view of an enhanced credit report produced by the system of FIG. 2. The enhanced credit report is presented to a customer terminal 211 either via electronic documents (e.g., .pdf) or served on a web page to be viewed by the customer terminal 211 on a web-browser, or as an XML data stream. Of course tangible copies of the report are optionally produced in the form of stored electronic copies, or on printed matter.

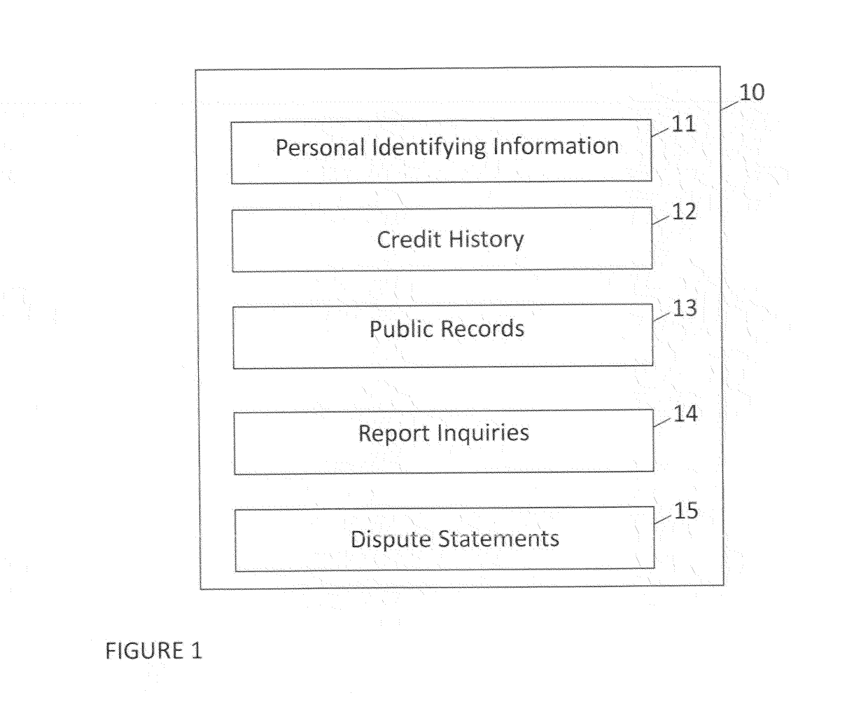

In the enhanced credit report 310, the traditional credit information 311 is similar to that shown in FIG. 1. Applicant information is shown in a first data area, includes information such as name, address (current and previous), social security number, Date of birth/age, and applicant identifier. However, additional information in the form of consumer property ownership and mortgage obligation records 312 is also included. In addition, property legal filings and tax payment status 313 is available as well as information regarding rental applications, collections and evictions 314. Charge offs and installment loans from payday and online lenders 315 is provided in addition to consumer specific bankruptcies, liens, judgments and child support obligations 316. This complete set of data is not generally available from traditional credit reporting agencies but nevertheless is valuable for a broad range of lending industries that includes mortgage, automotive, credit card, subprime, direct-to-customer, and others. This enhanced credit report assists lenders by mitigating a risk by uncovering additional debt obligations and increases revenue by identifying previously hidden credit behavior that could improve a consumer's credit profile, leading to new lending opportunities.

In addition, the enhanced credit report includes a property summary 317, which among other things includes a summary of current properties owned and properties recently owned. This summary provides an estimate of the combined value of the properties (through sales records and/or AVM estimate), estimated original debt amount, and estimated combined Loan-to-value ratio of the properties. The property summary 317 also includes an indication of whether the person is the owner of the current property address, and whether the property is likely occupied by the owner. Furthermore, the property summary 317 includes an indication of whether the current address has transferred ownership in the last 120 days.

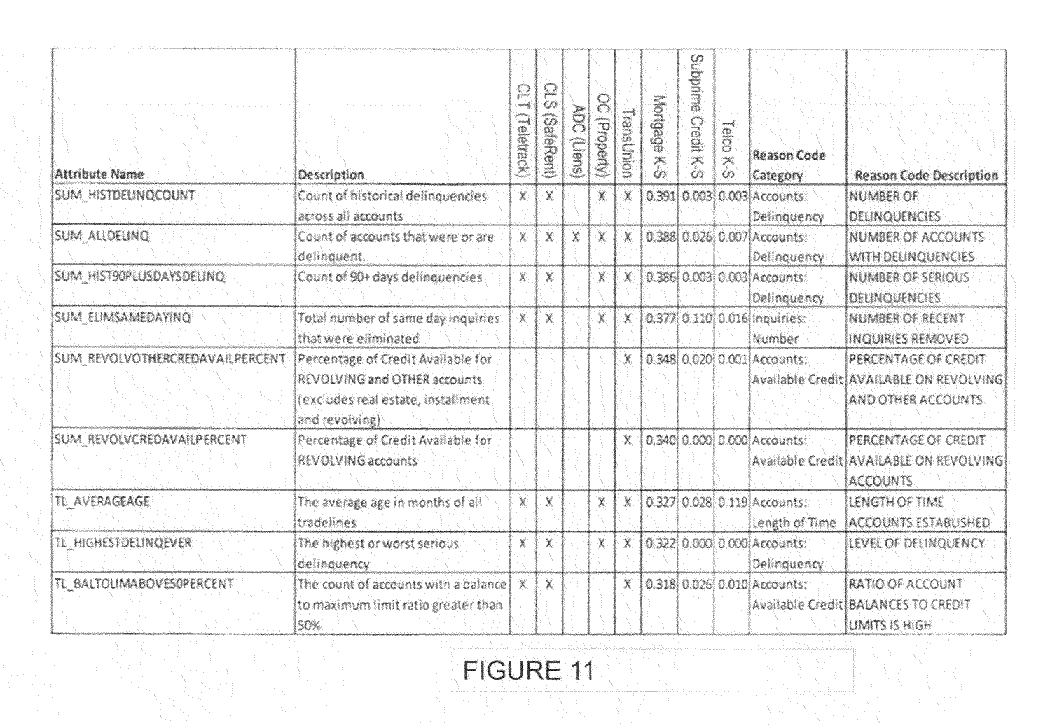

In the score information 318 of the enhanced credit report credit scores are provided that are calculated according to a variety of scoring techniques, which include FICO Mortgage Score Powered by CoreLogic, CoreLogic educational score, BEACON, FICO II, FICO Classic, along with which data sources were used for each scoring model, and the factors that most greatly affected the score (e.g., length of time revolving credit has been established, too few accounts with recent payment information, too many inquiries within the last 12 months, and the level of delinquencies on accounts. These factors are used as part of the respective scoring models to arrive at a resulting enhanced credit score (see U.S. patent application Ser. No. 13/644,905 for a more detailed description on how the enhanced credit scores are calculated). One type of enhanced credit score is an “education score” that is developed using the process described in U.S. patent application Ser. No. 13/644,905, although using attributes that are described in reference to FIGS. 11-13.

A third data area includes a credit summary 319 and includes different types of accounts, such as installment and revolving accounts, but also real estate accounts, with outstanding balance amounts. Included in the credit summary is the number of inquires made, including inquires for the real estate accounts. For each account, there is a current status (trendline) shown, which includes payments and when paid. A historical delinquency (count) table is provided for each account and identifies a last delinquency and the time frame for when payment was due.

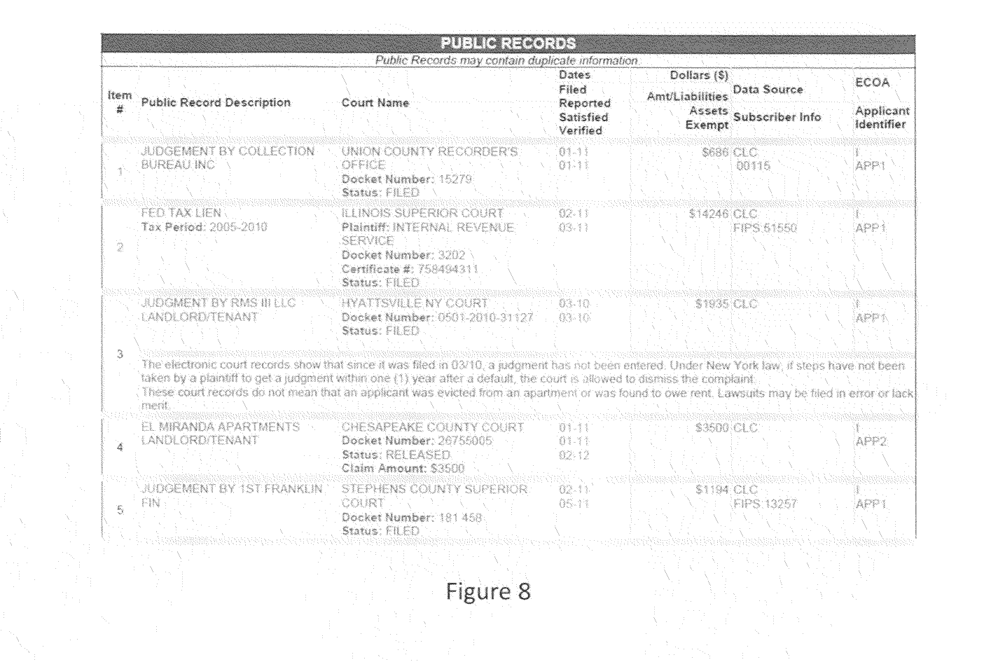

Another data area is dedicated to public records filings (Property legal filings and Tax payment status 313), as will be discussed in more detail with respect to FIG. 8. The fields include a public record description, the court name/plaintiff name/docket number/status. Also included are the filing and release dates of the public records, the dollar amount at issue, the data source, and applicant identifier, among other data elements. The data is acquired through CORELOGIC businesses as well as other public repositories.

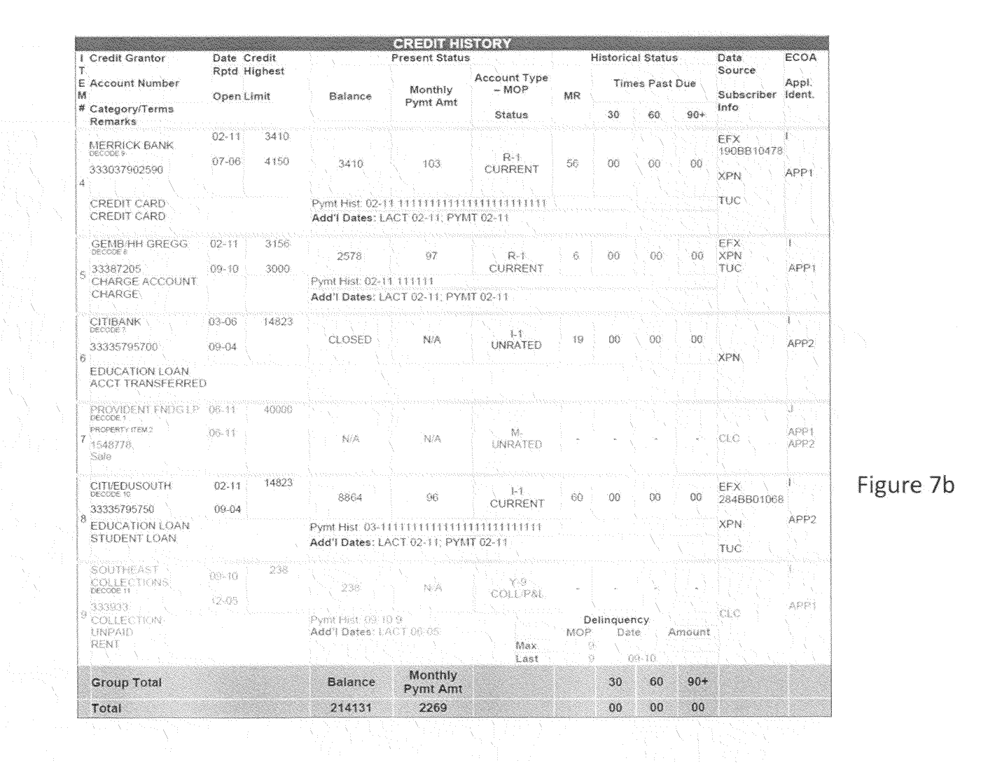

Another data area is dedicated to credit history (included in 311, or separately presented from the conventional credit information in a different section), as will be discussed in more detail with respect to FIGS. 7a and 7b. The credit history includes fields for identifying (1) category/terms of credit, date (reported and opened), credit level (highest and limit), present status (including balance, monthly payment, account type), historical status (including times for past due), data source, and applicant identifier. Because the enhanced credit report includes information on real properties, one of the types of “category” includes mortgages, refinances and liens. One unconventional aspect of the credit history included in the enhanced credit report is a displayed linkage between mortgage debt to a property record, providing clarity to the properties represented by the mortgage debt. Other sections that may be included in credit history are payday lending 329 (see item 3 in FIG. 7a), checking account data 328, utility payment history 327, and mobile phone payment history 326.

The ECRPC 201 is programmed to retrieve the legal transactions on a given property that relate to the specific borrower, if a mortgage obligation exists and is open or paid, if subsequent transactions update that mortgage obligation, as in the case of a Notice of Default, Foreclosure, Release or Assignment, and applies FCRA purge criteria to determine if a credit liability should be reflected on the credit report. A created credit liability is then compared to the traditional bureau credit reports, and invokes matching criteria to determine if the CREDCO-created mortgage credit liability should be merged with the information for that mortgage account from the traditional credit bureaus. A reference to connect to the property transaction history is included on the credit liability, and updates applied such as more severe derogatory payment conditions. If the property transaction does not appear on the traditional credit bureau, the CREDCO mortgage credit liability will be listed for that source only.

Similarly, transactions for the other CORELOGIC data, such as rental and non-traditional credit accounts, are also compared to the traditional credit bureaus to determine if merging with that data is appropriate, and if merged, unique CORELOGIC data is added to the credit liability to provide a more comprehensive representation of the borrower's credit activity.

A fraud verification section 321, alias section 322, which identifies other names used by a consumer or property owner, and employment history section 323 are also included on the enhanced credit report 310.

An optional section is for consumer alerts and statements by the consumer, consumer statement 324 in FIG. 3. In this section, for example, the fields may include what features the consumer has authorized or not for establishing or extending credit to the consumer, as well as comments by the consumer perhaps contesting certain actions or reports made by credit agencies.

A credit queries section 325 of the report 310 (FIG. 3) is for reporting inquires made within a certain time frame, such as the last 24 months. A longer period of time is reflected for inquiries by prospective landlords, up to seven years. These list the entities which have received a copy of the borrower's credit report at a specific point in time.

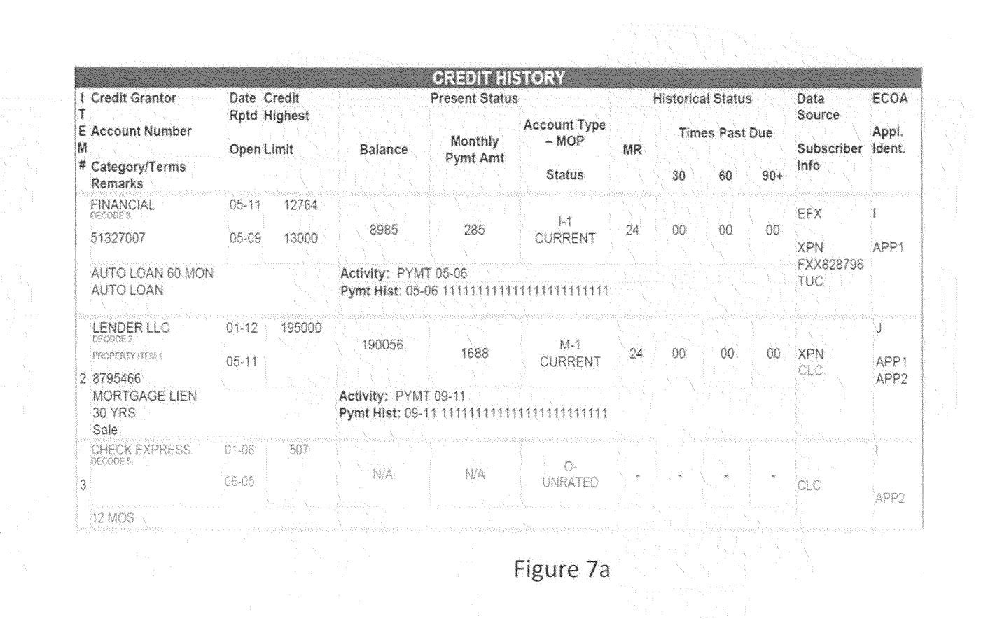

A summary of confirmed property transactions history section 320 is included in the report, and will be discussed in greater detail with respect to FIG. 6. Included in this section are fields for summary of the property, date of transfer, type of transfer (e.g., sale, refinance), value of sale, loan amount, type/rate, deed (e.g., trust, mortgage, deed), document number, transactors, and applicant identifier. This section also includes property address, owner, estimated market value, number and dollar amount of open liens, combined loan to value ratio, land use description, year and dollar amount of property tax, ownership status, and likely residence indicator.

Another optional section is a decode directory, which identifies the type of creditor, contact information, address, and data source. This section helps a user of the enhanced credit report to contact the creditor, or learn more about the creditor. Included in this information is the creditor or landlord phone number, which provides lenders with the ability to contact the borrower's creditors or landlord without performing an independent search.

Another section is for reporting errors, such as errors found in the data provided by a particular data source. A similar section provides a data area for summarizing the different sources of information and contacts.

One unique feature of the enhanced credit report is the reporting of property tax delinquencies, which the ECRPC 201 obtains from liens reported in public records database 210 and other data bases 209. With regard to the payday lending 320, the ECRPC 201 is programmed to detect when a payday loan is not repaid by a predetermined date, and the lender allows the loan to extend for another pay-period. By detecting this rollover of the loan, the ECRPC 201 is able to avoid reporting that the original loan was satisfied, or showing excessive outstanding loans.

Another unique feature of the enhanced credit report is the reporting of private loans, which are credit obligations contained in the RealCore Property databases 209. The CORELOGIC databases are populated with data scraped from courthouses in different geographic areas, thus allowing for the detection of otherwise undisclosed debt that would not appear on a standard credit report. This access to the courthouse data, and use to populate the enhanced credit report allows for more identification of private loans, or other debts, legal actions etc., than are reported via conventional credit reports. Sourcing the property transactions directly from courthouses also allows CREDCO to display new mortgage obligations earlier than they would appear on a standard credit report.

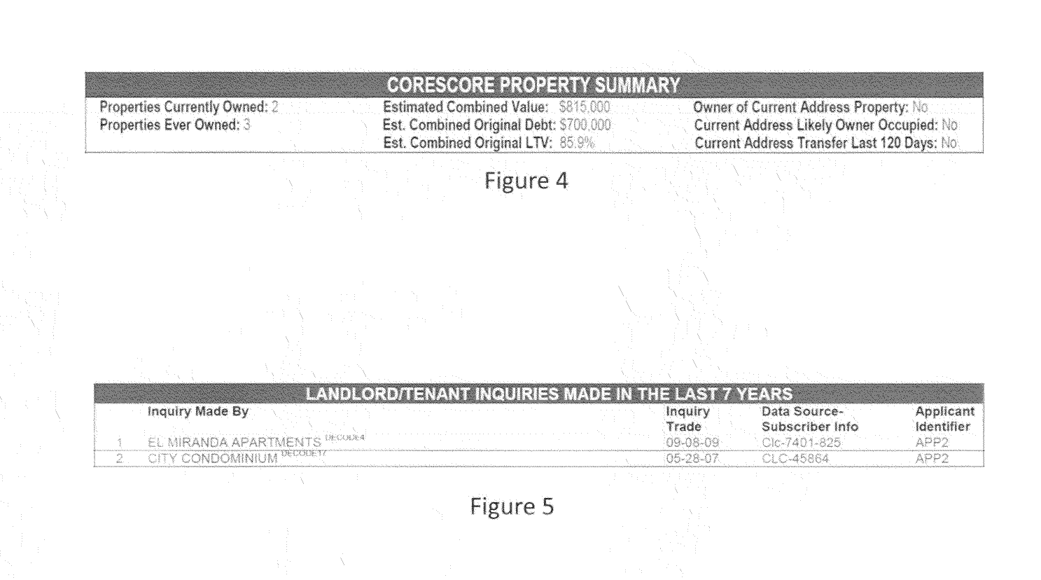

FIG. 4 is a more detailed table of the property summary 317 (FIG. 3). In this example, the consumer is shown to currently own three properties (as determined by a search, match and merge of data from the databases discussed above with respect to FIG. 2). Also included is the total number of properties the consumer ever owned. The total combined value is estimated to be $815,000, with an estimated combined value of $700,000, with an estimated combined original loan-to-value ratio of 85.9%.

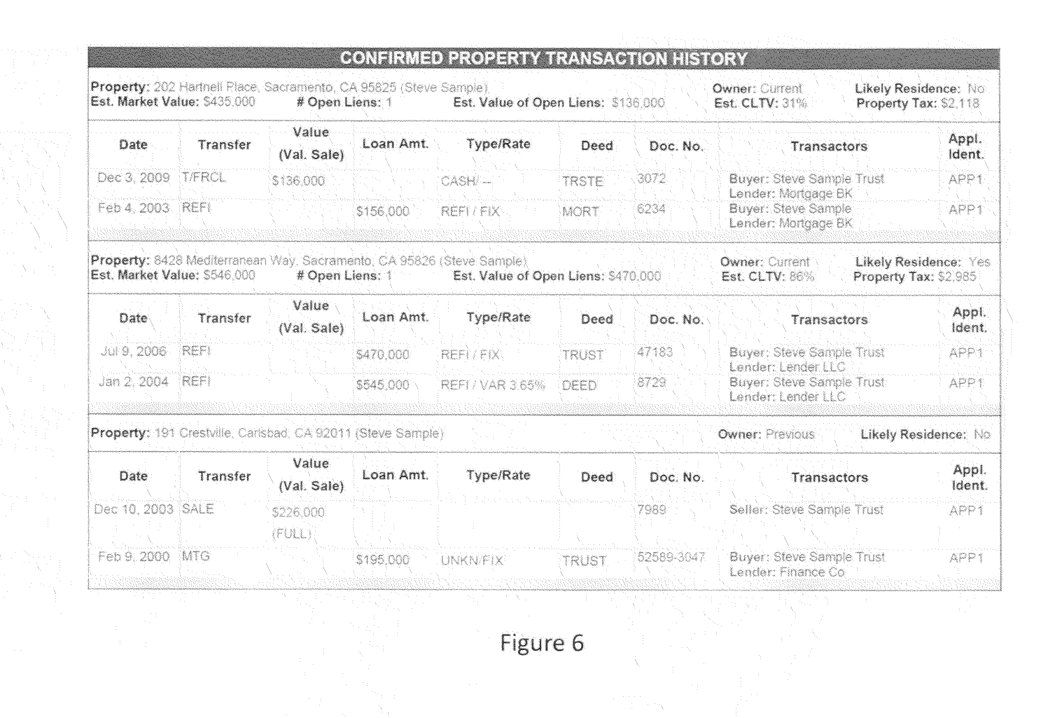

FIG. 5 is a more detailed table of landlord/tenant inquiries with is part of the credit queries section 325 of FIG. 3. This section shows the entity making the inquiry, when the inquiry was made, the data source and subscriber information (which is cross-referenced to the decode directory, previously discussed with respect to FIG. 3), and applicant identifier.

FIG. 6 is a more detailed table of an example Confirmed Property Transaction History section 320 (FIG. 3). This section illustrates the ability of the ECRPC 201 to filter out any transactions that are not related to the borrower, as well as provide other useful information to a potential lender. In the example of FIG. 6, the first two properties, 202 Hartnell Place, and 8428 Mediterranean Way, are presently owned by the borrower. These entries include address, estimated market value, no. of open liens and value of liens, estimated combined loan-to-value ratio, whether it is the likely residence of the owner (identified, for example, by whether the utilities for that property are in the name of the borrower), and property tax. For each of the currently owned properties, each transaction date, type of transfer (e.g., refinance or line of credit), value of the sale, loan amount, deed, document no., transactors and application identifier are listed. As for the previously owned property (in the case of FIG. 6, the property is 191 Crestville), the same fields are included although excluding the present market value, LTV, number of liens and property tax amount since they are no longer relevant.

FIGS. 7a and 7b are an exemplary credit history section that is separated from the conventional credit information 311 (FIG. 1). Different credit items are included, such as bank loans, mortgage liens, payday loans, credit cards, educational loans, and rent payments. The date, credit amounts (highest and limit), present balance, monthly payment amount, account type, payment history and times past due, data source and application identifier. As seen with item 2 in FIG. 7a, the enhanced credit report is able to link a mortgage debt record with a property record. Item 3 shows how a payday loan is identified and reported on the enhanced credit report. Furthermore, in FIG. 7b, item 7 illustrates an example of the ECRPC 201 retrieves a courthouse record and recognizes the courthouse record as a credit liability. Item 9 in FIG. 7b illustrates an example of how landlord data is transformed into a MISMO structure for reporting on a credit report.

FIG. 8 is an excerpt of a public records section of an enhanced credit report of the present embodiment. The entries include a description of the public record associated with the borrower, the court name, dates, money at issue, data source and applicant identifier. Additional details such as the years covered by a Federal Tax Lien may be included.

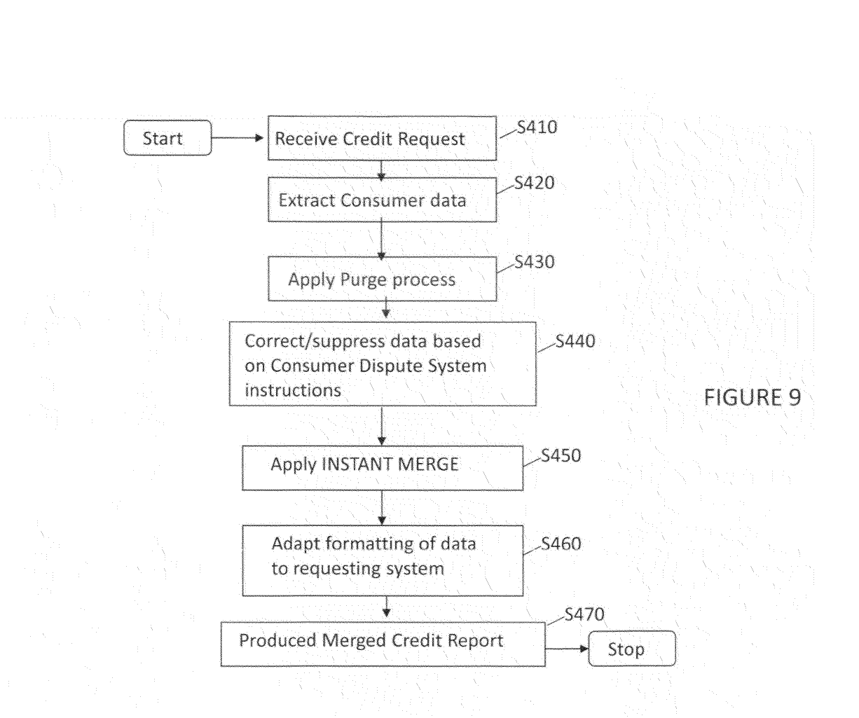

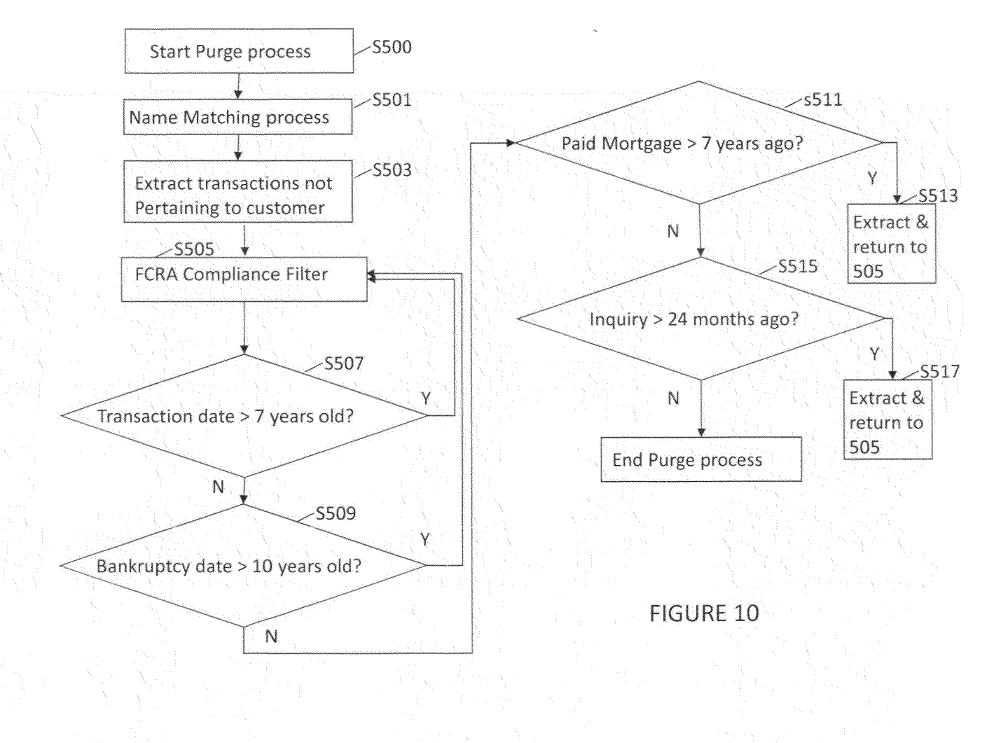

FIG. 9 is a flow chart describing a process flow for gathering enhanced information, purging redundant information, and ultimately producing a merged enhanced credit report. FIG. 9 is a summary high level process and this process begins in step S410 where a request is received for obtaining a credit report. This credit request may be made either directly to a CORESCORE service or by way of credit reports requested from the primary credit bureaus. The process then proceeds to step S420 where, based on the credit request, consumer data is extracted (e.g., name, address, social security number) that may be used, for example, to retrieve property data, rental data, alternative credit data, tax payment data and public record data for the consumers. The process then proceeds to step S430, where a purge process is performed to remove extraneous records from the data, as described in reference to FIG. 10. The process then proceeds to step S440 where corrections and/or suppressions of resulting data is made based on consumer dispute system instructions for that particular consumer's transactions.

Then the process proceeds to step S450, which applies the instant merge technology discussed in U.S. Pat. No. 5,274,547, previously incorporated herein by reference in its entirety. This technology allows for the comparing and blending of trade line and public data record items across all repositories into a consolidated view of their credit report. Greater detail of an exemplary merge process is described in U.S. provisional patent application Ser. No. 13/673,126. Additional refinements to the merge technology were added to the CREDCO system to account for the uniqueness of certain CORELOGIC data elements, such as property linkage, tax years, transaction history and rolling pay-day loans. The CORESCORE merge logic also accounted for nuances on the reporting of mortgage credit liabilities and public record items on the standard credit reports, further refining the ability to correctly match new credit items to those included on a standard credit report. As mentioned previously, incremental CORELOGIC data elements can be incorporated into the standard bureau credit liabilities and public record items. Great care was taken to fit all new data elements into existing MISMO standards, to facilitate the delivery of the CORESCORE credit report into the lender loan origination systems and scoring algorithms in use by FICO and other business entities.

Subsequently the process proceeds to step S460, where the data is formatted into a particular structure for delivery. In one example, MISMO format, version 2.3x may be used, although not required. The process then proceeds to step S470, where after logging the requesting party into a consumer's file and presenting a Consumer Disclosure Report that lists all bureaus and separate items in a stacked format, the enhanced credit report is produced for delivering electronically to the user through a user interface or is alternatively produced in a written publication containing only CORELOGIC CREDCO data to be sent to the requesting consumer. If the inquiry request is from a lender, the merged credit report is delivered to the requesting user in a merged enhanced credit report format.

FIG. 10 describes a more detailed process flow for this purge process. The purge process essentially applies a name matching process to ensure that the data does relate to the particular consumer, removes transactions that do not pertain to the consumer, deletes transactions that are inconsistent with the Fair Credit Reporting Act requirements, removes properties where the consumer paid the mortgage more than seven years previously and removes inquiries that occurred more than 24 months in the past (except for landlord inquiries which are retained seven years).

FIG. 10 shows a more detailed description of the purging process at step S430. The process begins in step S500 and then proceeds to step S501 where the name matching process is performed as previously discussed. Then the process proceeds to step S503 where an extraction of transactions is performed if the transaction does not relate to a particular customer. Then the process proceeds to step S505 where a process is performed for particular transactions to determine whether the Fair Credit Reporting Act has been complied with for particular transactions. The process proceeds to the query in step S507 where the particular transaction date is determined whether it has a derogatory payment transaction seven years old or older. If so the transaction is filtered out in compliance with the FCRA. However, if the response to the query is negative, the process proceeds to step S509 where it is determined whether the transaction is a bankruptcy and if so, if the bankruptcy is more than ten years old. If so the bankruptcy is filtered and the process returns to step S505. However if the response to the query in step S509 is negative, the process proceeds to step S511 where another query is made. This query asks whether the mortgage has been paid greater than seven years ago. If so, the process proceeds to step S513 where that property history is extracted and the process returns to step S505. However, if the response to the query in step S511 is negative, the process proceeds to step S515 where it is determined whether a particular inquiry is more than 24 months old. If so, then the process proceeds to step S517, where the query is extracted and the process returns to step S505. Otherwise the process ends.

The enhanced Credit Report contains fully decisionable, FCRA-compliant consumer credit risk information. The associated data fields for property summary, credit history, property transaction history, public records, inquires identification information, and analytics and mapping to the enhanced Credit Report's mapping to public record, homeownership, landlord/tenant, and alternative credit fields is shown in CoreScore Data Dictionary (a copy of which is provided in U.S. Provisional Patent Application 61/673,126). Here it is shown that different FCRA permissible sections (e.g, property summary, credit history, confirmed property transaction, public records, inquiries, identification information and analytics are listed, with associated data fields. Also included is a long description of the data fields, and then an indication of which data field is relevant to each of four categories: Public Record; Homeownership; Landlord/Tenant; and Alternative Credit. The supplemental data is sourced from the CORELOGIC information databases of Property, Public Record, Tax, SafeRent and Teletrack that currently contain nearly 1 billion consumer transaction records. The data includes information about a consumer's property ownership and mortgage obligations, property legal filings and property tax payment status, rental applications, collections and evictions, inquiries, loans and charge-offs from payday and online lenders, and consumer-specific bankruptcies, evictions, liens, judgments and child support obligations—most of which have been shown to contain additional data types not generally available from traditional credit reporting agencies.

Additionally, because CORELOGIC collects property transaction and landlord judgment data directly from the courthouse, rather than relying on creditor or vendor reporting, new mortgage obligations and other public record transactions appear in an average of just 23 days, which can be up to 2 months sooner than traditional credit report updates. Lenders can obtain a more complete and reliable consumer credit profile for mortgages and non-traditional data sooner from CORELOGIC.

The enhanced credit report is created by merging consumer information with traditional credit report data in a single, integrated report format. The enhanced credit report's application expands across a broad range of lending industries, including mortgage, automotive, credit card, subprime, direct-to-consumer, and others. Delivered in seconds, the enhanced credit report helps lenders mitigate risk by uncovering additional debt obligations, and increase revenue by identifying previously hidden credit behavior that could improve a consumer's credit profile, leading to new lending opportunities.

The enhanced credit report information can be delivered in a variety of formats. For origination purposes the data is formatted in the same fashion as traditional credit reports, with the supplemental data merging in to the existing sections for identification, tradelines, public record, inquiries, consumer statements and summaries.

While the traditional credit reporting agencies rely on credit grantors to report mortgage loan activity to them, the databases 209 and 210 are populated in advance by retrieving millions of records in advance from courts nationwide. All of the transactions related to a property, including the initial deed and follow-on legal activities such as a foreclosure or sale, are collected this way. The ECRPC 201 stores these transactions in the FCRA infrastructure. For delivery on the enhanced credit report, the property transactions are formatted as credit report tradelines.

Creating a standard credit report tradeline from these property filings is performed by the ECRPC 201, and its delivery format uses the MISMO XML mortgage industry-standard format for output of the enhanced credit report data. The format accommodates lenders' submission of loan activity to the credit repositories using the Metro 2 format, with full display of the credit bureau report output. This reporting format includes items such as monthly payment status and amount owing, and is designed so that the next month's submission is an update for the same credit loan.

The legal property transactions collected from courthouses nationwide are separate filings and are currently stored in RealCore FCRA, which is a CoreLogic database 209 (FIG. 2) in the FCRA infrastructure. Each property transaction is considered to determine how it might update the previous filings about the borrower for that property. For example, a Refinance transaction is a new lien that replaces one or more existing liens. A Notice of

Default is a proceeding involving an existing lien. Through normalization, merge and update logic processes described below, an accounting is available for the multiple transactions for a consumer that can occur on a single property.

### Match Criteria

One aspect of creating the enhanced credit report is that the ECRPC 201 merges supplemental data with one, two or three of the traditional credit reports, and identifies the accounts that exist on both the CoreScore databases and the credit reports from Equifax, Experian or TransUnion. To perform this comparison, the following exemplary match logic is applied in a computer implemented process.

CoreScore Trade Attributes (as described in U.S. Pat. No. 5,247,547):

repository information and identification

account information

date opened

high credit

payment history

monthly payment

balance data

Intra deduplication of CoreScore Trades:

Trades are considered as duplicates in the following condition

If the CREDIT_LIABILITY: HighBalanceAmount and

CREDIT_LIABILITY:_AccountOpenedDate match exactly.

If match is found at step (a) de-dupe the trades. If they are reported for Borrower and Co-Borrower, set the CREDIT_LIABILITY:._AccountOwnershipType=Joint and set the BorrowerID accordingly.

De-dupe the Footnotes or Remarks while de-duping the trades if they are duplicates, i.e. CREDIT_COMMENT_Code is same.

Inter bureau merge of Credit-Trades and CoreScore-Trades:

Trades are considered as duplicates

If the CREDIT_LIABILITY: HighBalanceAmount is within 5% tolerance and

CREDIT_LIABILITY:_AccountOpenedDate are within +/−2 month window (i.e. adjacent months).

If match is found at step (3a) de-dupe the trades.

Merge Rules:

Retain the following attributes for then merged trade.

Retain all the attributes/entries of the Credit Trade

Append any Remarks from transaction to the merged trade

Set the Manner of Payment of recently reported trade for the merged trade.

Association between Property Transaction and Credit Trade:

If the Trade.HighCredit and SalesAndLoanHistory.FirstLoanAmount or SecondLoanAmount are within 5% tolerance

and

If the Trade.DateOpen and SalesAndLoanHistory.OwnershipReportedDate are within +/−2 month window

Associate the SalesAndLoanHistory to Trade

Other types of liens such as a Homeowner Association lien on the property are accounted for in the credit tradeline as a Credit Comment.

Normalization

Additional standardization is required so that the CoreScore property transactions fit into the credit tradeline structure. The type of mortgage is converted to existing MISMO XML definitions for Credit Loan Type as follows:

| INPUT Transaction: | OUTPUT | |
|---|---|---|
| loanTypeShortDescription | CREDIT_LIABILITY: CreditLoanType | Category Code |
| ASMPTN | Mortgage | 98 |
| BALLOON | Mortgage | 98 |
| CASH | RealEstateSpecificTypeUnknown | 96 |
| CNST | ConstructionLoan | 170 |
| CNV | ConventionalRealEstateMortgage | 99 |
| DMND | Mortgage | 98 |
| FHA | FHARealEstateMortgage | 47 |
| GRAD | Mortgage | 98 |
| GROWEQ | Mortgage | 98 |
| LHM | Mortgage | 98 |
| PP | RealEstateSpecificTypeUnknown | 96 |
| REFI | Refinance | 158 |
| REFI/EQ | Refinance | 158 |
| REVOLV | HomeEquityLineOfCredit | 147 |
| SBA | CommercialMortgage | 140 |
| UNKN | RealEstateSpecificTypeUnknown | 96 |
| VA | VeteransAdministrationRealEstateMortgage | 130 |
| WRP | RealEstateSpecificTypeUnknown | 96 |

Property Owner Checking

Extra care is needed when including a mortgage credit obligation on a consumer's credit report, to ensure they are the individual that currently or previously owned the property. The enhanced Credit Report incorporates these additional checks:

if Transaction:History:. buyer or buyer2 matches CREDIT_FILE:BORROWER (s) set _OwnershipStatusType=CURRENTLY_OWNED

else if Transaction:History:. buyer or buyer2 matches OwnerConnect: Borrower:BorrowerName set _OwnershipStatusType=CURRENTLY_OWNED

else if Transaction:History:. buyer or buyer2 matches OwnerConnect: Borrower:BorrowerAliasList:IdentityNameSSNCount:Name set

_OwnershipStatusType=CURRENTLY_OWNED

else if Transaction:History:. seller or seller2 maches CREDIT_FILE:BORROWER (s) set _OwnershipStatusType=PREVIOUSLY_OWNED

else if Transaction:History:. seller or seller2 matches OwnerConnect: Borrower:BorrowerName set _OwnershipStatusType=PREVIOUSLY_OWNED

else if Transaction:History:. seller or seller2 matches OwnerConnect: Borrower:BorrowerAliasList:IdentityNameSSNCount:Name set

_OwnershipStatusType=PREVIOUSLY_OWNED

Else if set _OwnershipStatusType=UNDETERMINED

This name matching logic accounts for the following scenarios, and uses a point threshold system to determine if a transaction will display on a consumer's report.

a) Exact matches (e.g., John Smith is reported in the ownership record and is listed in the Buyer/Seller for a specific property transaction)

b) Name flipping (e.g., John Smith is the name found in the ownership record, however Smith John is reported in the Buyer/Seller name for a specific property transaction) consider this as a match.

c) Nicknames and/or slight misspellings/similar sounds (e.g., Smith is listed as Smih or Smit, or Smithe)

d) TRUST with last name (e.g., Smith Trust or TRUST SMITH or Smith Family Trust)

e) Middle Name usage (e.g., John Smith is not the same as Alex John Smith)—In this scenario, if the Report is being processed for Alex John Smith, if buyer/seller is John Smith, don't set name as match)

As discussed above, one example of an enhanced credit score is an educational score that is a consumer-level credit score that is more predictive of mortgage payment delinquency than currently available credit scores based on the enhanced credit report and enhanced credit score described herein. The educational score draws upon a merging of data from various sources including traditional bureau reports; RealEC FCRA property data; ADC liens, judgments and bankruptcies; SafeRent; Teletrack, and loan performance data. The present

| Attribute definition | Data Source |
|---|---|
| [symbol] | [symbol] |

[symbol]

indicates data missing or illegible when filed

inventor recognized that unique data exists in RealCore property databases 209 that are not present in other sources. The presence of this unique data includes information regarding an open mortgage lien and a closed mortgage lien, as well as property value and attributes for a particular property. Also as discussed above, the public records filings provide information with regard to eviction, bankruptcy, judgment and liens, all of which are indicators of the credit worthiness of a particular consumer. Furthermore, the availability of rental information including rental inquiries and landlord collections are present in the CoreLogic databases 205 that are relevant to whether a consumer will be a reliable payer as a credit applicant. Also, payday loans, internet service provider payments, and other utility payments, as well as rent-to-own payments, offer credit information with regard to a non-traditional inquiry and a non-traditional charge-off, once again all of which are available information and an indicator as to whether or not a consumer would be a reliable payer of a credit obligation.

A listing of a subset of the variables (attributes) used in the scoring binning process or credit evaluation process (as described in U.S. patent application Ser. No. 13/644,905) is provided below in Table 1.

TABLE 1

| | |
|---|---|
| BALANCE ON MOST RECENT RENTAL | RENTAL |
| ACCOUNT IN COLLECTION | |
| LANDLORD TENANT JUDGEMENTS | RENTAL |
| AVERAGE AGE | |
| LANDLORD TENANT COLLECTION | RENTAL |
| AVERAGE AGE | |
| LANDLORD TENANT COLLECTION | RENTAL |
| IN LAST 2 4MONTHS AMOUNT | |
| HIGHEST AMOUNT OF LANDLORD | RENTAL |
| TENANT JUDGEMENT IN LAST 24 | |
| MONTHS | |
| PRESENCE OF PROPERTY LIEN IN | PUBLIC RECORD |
| LAST 24 MONTHS | |
| TOTAL AMOUNT OF LIENS ON | PROPERTY |
| CURRENTLY OWNED PROPERTY | |
| AVERAGE DAYS OPEN SECOND | PROPERTY |
| LOAN | |
| CONSTRUCTION IN 1 YEARS | PROPERTY |
| CURRENTLY OWNED SINGLE | PROPERTY |
| FAMILY RESIDENCE | |
| LATEST PROPERTY NOTICE OF | PROPERTY |
| DEFAULT AGE | |
| LATEST PROPERTY NOTICE OF | PROPERTY |
| DEFAULT AMOUNT | |
| LOAN TO VALUE ABOVE 100 | PROPERTY |
| PERCENT EVER | |
| LATEST REFINANCE EQUITY AGE | PROPERTY |
| NOTICE OF DEFAULT TRANSACTIONS | PROPERTY |
| IN 2 YEARS | |
| NON-ARMS LENGTH TRANSACTIONS | PROPERTY |
| IN 1 YEARS | |
| OPEN FIRST PRIVATE PARTY LOAN | PROPERTY |
| EVER | |
| AMOUNT OF OPEN SECOND PRIVATE | PROPERTY |
| PARTY LOAN | |
| OPEN LOAN TO VALUE ABOVE 95 | PROPERTY |
| PERCENT IN 180 DAYS | |
| RATIO OF REAL ESTATE LOAN TO | PROPERTY |
| ESTIMATED PROPERTY VALUE | |
| LENGTH OF TIME SINCE OPEN REAL | PROPERTY |
| ESTATE LOANS WERE ESTABLISHED | |

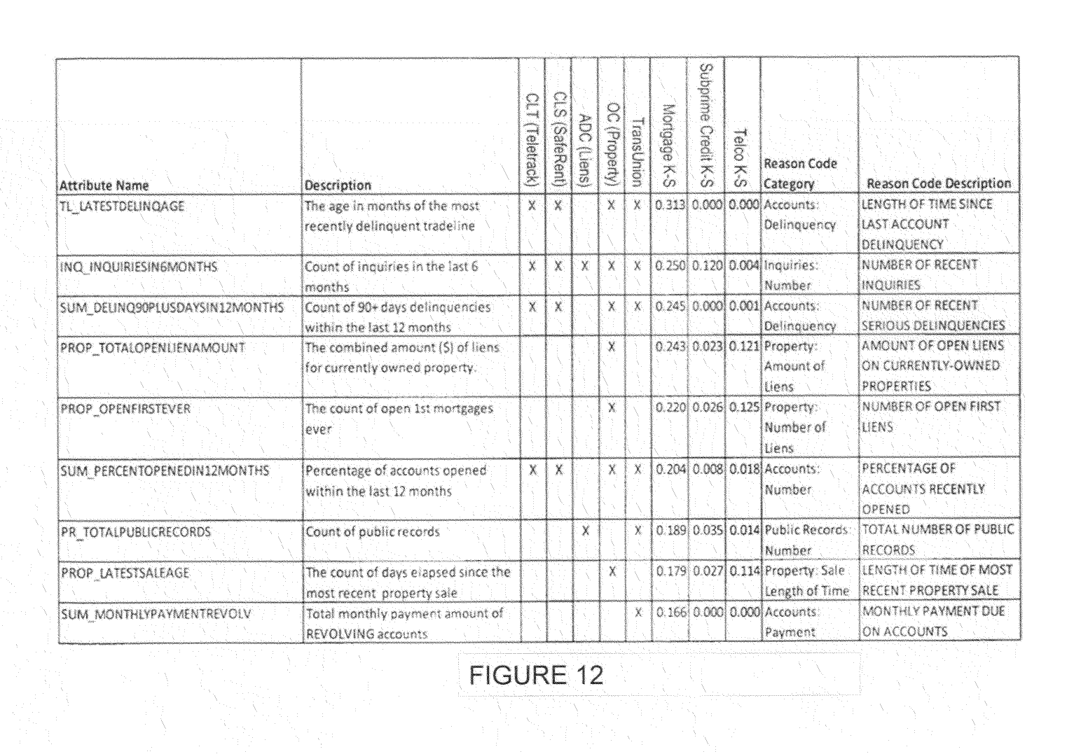

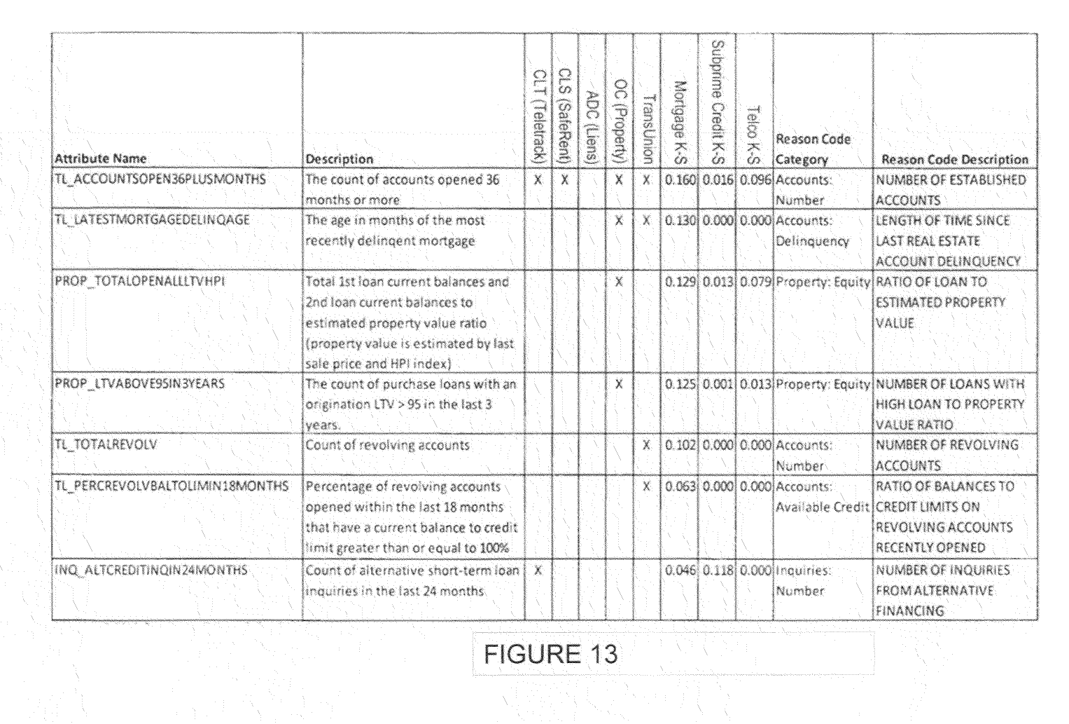

After variable selection prebinning, and initial binning, a final scorecard is developed. Although Table 1 provides a description of unique attributes associated with the education score, a more complete list of attributes included in the scorecard are provided in FIG. 11, FIG. 12 and FIG. 13. Included in each of FIGS. 11, 12, and 13 is a description of the attribute name, a description of the attribute, as well as a reason code description explaining the reason why a certain score may be given. For example in FIG. 11, a first attribute is SUM_HISTDELINQCOUNT indicates that information is received from Teletrack, SafeRent, property database as well as a traditional credit report. The above-described merge process merges the information to provide a cumulative history of the delinquencies, and credit obligations, sub-prime credit, as well as other variable weighting factors are applied to an overall score.

Regarding the category of variables, standard bureau attributes are included, which include number (by time period) of inquiries, trade lines, payments, late payments, delinquencies, charge-offs, liens, bankruptcies, total credit available, debt/credit ratio, for example. The same variable definitions may be used for ADC, SafeRent and Teletrack as for the main three credit bureaus. Regarding property data, typical variables that are used are number of sales, refinances, construction, timeshare, loans by type, notices of default, foreclosures, for example. Other property data include total first loans to estimated property value ratio; number of properties by type for the person who owns or has owned the properties; average/max/min number of days since origination; number/trend of sales price, square footage, price per square foot, lot size, bedrooms, baths; and sum of estimated property values minus sum of first loans. Once again these variables are used to create an education model scorecard that is used to calculate an education score according to the process described in U.S. patent application Ser. No. 13/644,905.

Regarding how reason codes are ordered and selected, for each variable the points lost (relative to a maximum) are a difference between the actual score and the maximum achievable score. The variables by points lost are sorted in a descending order. Up to the four top reasons are selected with points lost greater than zero. If the number of credit inquiries is a factor and not already in the top four, this reason code is added. Once again the reason codes are provided in FIGS. 11-13 as well as the reason code descriptions. The enhanced credit report includes the listing of up to the four top reasons provided.

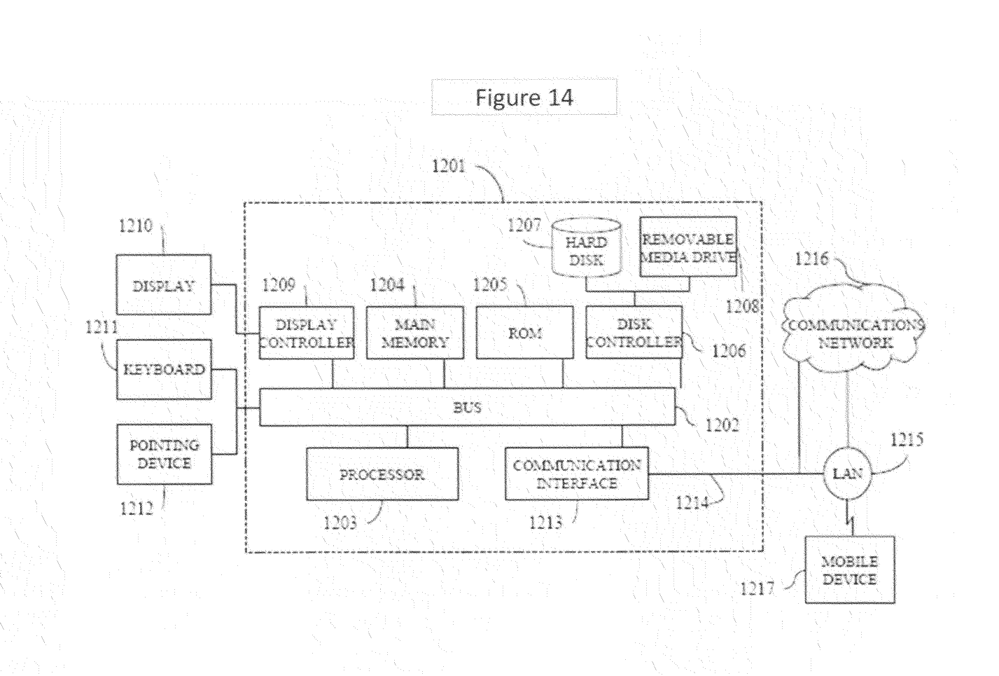

FIG. 14 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any non-transitory medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A method for generating an enhanced credit report, comprising:
receiving via a network communication channel, a credit request for an enhanced credit report, wherein the credit request includes identifying data of a consumer;
extracting from a data repository consumer data that is associated with the identifying data contained in the credit request;
querying another data repository for supplemental credit data that is associated with the consumer data and not included within or as a section of a conventional credit report provided by a major credit bureau;
merging with enhanced credit report processing circuitry the supplemental credit data and at least a portion of credit information included in the conventional credit report and producing a Federal Fair Credit Reporting Act compliant enhanced credit report that contains the supplemental credit data, and an enhanced credit score.

2. The method of claim 1, wherein
the supplemental credit data includes at least one of consumer property ownership information and mortgage obligation records.

3. The method of claim 1, wherein
the supplemental credit data includes a property legal filing made at a courthouse and an indication of a credit liability on the enhanced credit report based on the property legal filing made at the courthouse.

4. The method of claim 1, wherein
the supplemental credit data may include at least one of rental application, rent collection and eviction status.

5. The method of claim 1, wherein
the supplemental credit data includes at least one of inquiries, loans and charge-offs of pay-day or alternative credit lenders.

6. The method of claim 1, wherein
the supplemental credit data includes at least one of consumer-specific bankruptcy, liens, judgments and child-support obligations.

7. The method of claim 1, wherein
the supplemental credit data includes a property tax payment status.

8. The method of claim 1, further comprising:
re-formatting with normalization and merge logic the supplemental credit data from a different format to a MISMO, print or alternate format that is used in the enhanced credit report.

9. The method of claim 1, further comprising:
calculating an enhanced credit score using scorecard attributes associated with the supplemental credit data, said scorecard attributes including a rental property-related attribute.

10. The method of claim 9, wherein the rental property-related attribute includes at least one of BALANCE ON MOST RECENT RENTAL ACCOUNT IN COLLECTION, LANDLORD TENANT JUDGMENTS AVERAGE AGE, LANDLORD TENANT COLLECTION AVERAGE AGE, LANDLORD TENANT COLLECTION IN LAST 24 MONTHS AMOUNT, and HIGHEST AMOUNT OF LANDLORD TENANT JUDGMENT IN LAST 24 MONTHS.

11. The method of claim 1, further comprising:
calculating an enhanced credit score using scorecard attributes associated with the supplemental credit data, said scorecard attributes including PRESENCE OF PROPERTY LIEN IN LAST 24 MONTHS or other property-related predictive attributes.

12. The method of claim 1, further comprising:
calculating an enhanced credit score using scorecard attributes associated with the supplemental credit data, said scorecard attributes including calculating an enhanced credit score using scorecard attributes associated with the supplemental credit data, said scorecard attributes including at least one of TOTAL AMOUNT OF LIENS ON CURRENTLY OWNED PROPERTY, AVERAGE DAYS OPEN SECOND LOAN, CONSTRUCTION IN 1 YEAR, CURRENTLY OWNED SINGLE FAMILY RESIDENCE, LATEST PROPERTY NOTICE OF DEFAULT AGE, LATEST PROPERTY NOTICE OF DEFAULT AMOUNT, LOAN TO VALUE ABOVE 100 PERCENT EVER, LATEST REFINANCE EQUITY AGE, NOTICE OF DEFAULT TRANSACTIONS IN 2 YEARS, NON-ARMS LENGTH TRANSACTIONS IN 1 YEARS, OPEN FIRST PRIVATE PARTY LOAN EVER, AMOUNT OF OPEN SECOND PRIVATE PARTY LOAN, OPEN LOAN TO VALUE ABOVE 95 PERCENT IN 180 DAYS, RATIO OF REAL ESTATE LOAN TO ESTIMATED PROPERTY VALUE, and LENGTH OF TIME SINCE OPEN REAL ESTATE LOANS WERE ESTABLISHED, or other predictive attributes.

13. A system for producing an enhanced credit report, comprising:
a communications interface that receives via a network communication channel a credit request for an enhanced credit report, wherein the credit request includes identifying data of a consumer;
processing circuitry that
extracts from a data repository consumer data that is associated with the identifying data contained in the credit request,
queries another data repository for supplemental credit data that is associated with the consumer data and not included as an item or in a section of a conventional credit report provided by a major credit bureau, and
merges the supplemental credit data and at least a portion of credit data included in the conventional credit report and produces a Federal Fair Credit Reporting Act compliant enhanced credit report that contains the supplemental credit data, and an enhanced credit score.

14. The system of claim 13, wherein
the supplemental credit data includes at least one of consumer property ownership information and mortgage obligation records.

15. The system of claim 13, wherein
the supplemental credit data includes a property legal filing made at a courthouse.

16. The system of claim 13, wherein
the supplemental credit data includes at least one of rental application, rent collection and eviction status.

17. The system of claim 13, wherein
the supplemental credit data includes at least one of inquiries, loans and charge-offs of pay-day or alternative credit lenders.

18. The system of claim 13, wherein
the supplemental credit data includes at least one of consumer-specific bankruptcy, liens, judgments and child-support obligations.

19. The system of claim 13, wherein
the supplemental credit data includes a property tax payment status.

20. The system of claim 13, wherein the processing circuitry re-formats the supplemental credit data from a different format to a MISMO, print or alternate format that is used in the enhanced credit report.

21. The system of claim 13, wherein the processing circuitry calculates an enhanced credit score using scorecard attributes associated with the supplemental credit data, said scorecard attributes including a rental property-related or other predictive attributes.

22. The system of claim 21, wherein the rental property-related attribute includes at least one of BALANCE ON MOST RECENT RENTAL ACCOUNT IN COLLECTION, LANDLORD TENANT JUDGMENTS AVERAGE AGE, LANDLORD TENANT COLLECTION AVERAGE AGE, LANDLORD TENANT COLLECTION IN LAST 24 MONTHS AMOUNT, and HIGHEST AMOUNT OF LANDLORD TENANT JUDGMENT IN LAST 24 MONTHS or other predictive attributes.

23. The system of claim 13, wherein the processing circuitry calculates an enhanced credit score using scorecard attributes associated with the supplemental credit data, said scorecard attributes including PRESENCE OF PROPERTY LIEN IN LAST 24 MONTHS or other predictive attributes.

24. The system of claim 13, wherein the processing circuitry
calculates an enhanced credit score using scorecard attributes associated with the supplemental credit data, said scorecard attributes including calculating an enhanced credit score using scorecard attributes associated with the supplemental credit data, said scorecard attributes including at least one of TOTAL AMOUNT OF LIENS ON CURRENTLY OWNED PROPERTY, AVERAGE DAYS OPEN SECOND LOAN, CONSTRUCTION IN 1 YEAR, CURRENTLY OWNED SINGLE FAMILY RESIDENCE, LATEST PROPERTY NOTICE OF DEFAULT AGE, LATEST PROPERTY NOTICE OF DEFAULT AMOUNT, LOAN TO VALUE ABOVE 100 PERCENT EVER, LATEST REFINANCE EQUITY AGE, NOTICE OF DEFAULT TRANSACTIONS IN 2 YEARS, NON-ARMS LENGTH TRANSACTIONS IN 1 YEARS, OPEN FIRST PRIVATE PARTY LOAN EVER, AMOUNT OF OPEN SECOND PRIVATE PARTY LOAN, OPEN LOAN TO VALUE ABOVE 95 PERCENT IN 180 DAYS, RATIO OF REAL ESTATE LOAN TO ESTIMATED PROPERTY VALUE, and LENGTH OF TIME SINCE OPEN REAL ESTATE LOANS WERE ESTABLISHED or other predictive attributes.

25. A non-transitory computer readable storage medium having stored therein computer readable instructions that when executed by processing circuitry performs a method for generating an enhanced credit report, comprising:
receiving via a network communication channel, a credit request for an enhanced credit report, wherein the credit request includes identifying data of a consumer;
extracting from a data repository consumer data that is associated with the identifying data contained in the credit request;
querying another data repository for supplemental credit data that is associated with the consumer data and not included as an item or in the section of a conventional credit report provided by a major credit bureau;
merging with the processing circuitry the supplemental credit data and at least a portion of credit data included in the conventional credit report and producing a Federal Fair Credit Reporting Act compliant enhanced credit report that contains the supplemental credit data, and an enhanced credit score.
